(19) United States
(12) Patent Application Publication
(10) Pub. No.: US 2019/0205006 A1
(43) Pub. Date: Jul. 4, 2019

(54) Information Processing Apparatus, Image Forming Apparatus, and Computer-Readable Recording Medium

(71) Applicant: Konica Minolta, Inc., Tokyo (JP)

(72) Inventor: Xingyue Li, Amagasaki-shi (JP)

(73) Assignee: Konica Minolta, Inc., Tokyo (JP)

(21) Appl. No.: 16/211,711

(22) Filed: Dec. 6, 2018

(30) Foreign Application Priority Data
Dec. 28, 2017 (JP) 2017-253294

(51) Int. Cl. G06F 3/0488; G06F 3/0485; G06F 3/12

(52) U.S. Cl. CPC G06F 3/0488; G06F 3/0485; G06F 3/1279; G06F 3/1237; G06F 3/1211

(57) ABSTRACT

A display screen in which input of setting of a setting item is accepted includes a first screen including a first number of objects for accepting inputs of two or more setting items and a second screen including a second number of objects for accepting input of at least one setting item. When an operation to select an object is accepted in the first screen while the first screen is shown as the display screen, a hardware processor has the display screen switched from the first screen to the second screen and has the selected object arranged in the switched second screen.

The entire disclosure of Japanese Patent Application No. 2017-253294 filed on Dec. 28, 2017 is incorporated herein by reference in its entirety.

### BACKGROUND

### Technological Field

The present disclosure relates to an information processing apparatus in which a setting item can be set, an image forming apparatus, and a computer-readable recording medium.

### Description of the Related Art

An information processing apparatus such as a personal computer (PC) includes a printer driver for utilizing an image forming apparatus. A print condition set for the printer driver includes a plurality of setting items (for example, “staple” and “color/monochrome”). The printer driver has a user interface (UI) screen shown, the user interface screen including an image of a setting item for accepting input of a print condition from a user. The UI screen includes a normal setting screen in which an image of a normal (default) setting item is arranged and a user setting screen (which is also called a MyTab screen) in which an image of a setting item preferred by a user is arranged.

The user can edit by addition and deletion, a setting item to be arranged in the user setting screen. In editing the user setting screen, the user clicks an edit button. Then, the information processing apparatus shows a list of normal print setting items and a list of setting items in the user setting screen in different dialogues. The user edits the user setting screen by operating an add/delete button or an up/down button in the dialogue.

This edition method, however, is performed by operating a button. Therefore, an operation to change arrangement of or add a setting item in the user setting screen is bothersome. Since the setting item is shown only with characters in the dialogue, it is difficult to know during edition, how an image of a setting item is arranged in the user setting screen. In order to check the user setting screen halfway through edition, switching from an edition screen such as the dialogue to the user setting screen has had to be made.

Various techniques have conventionally been proposed under such circumstances. For example, in an information processing apparatus in Japanese Laid-Open Patent Publication No. 2015-46123, a user flicks a component arranged in a screen. When the component moves out of the screen and disappears from the screen, transition to a screen selection mode is made and switching to a screen selected by the user is made. The component which has disappeared is shown and arranged in the switched screen.

### SUMMARY

In Japanese Laid-Open Patent Publication No. 2015-46123, when a component is to be arranged in a screen, an operation by a user to have the component disappear from the screen and an operation by the user to switch the screen have been required and operability has not been high. Therefore, a technique to lessen user's time and effort required for edition of a screen such as arrangement of a component in the screen has been demanded.

To achieve at least one of the abovementioned objects, according to an aspect of the present invention, an information processing apparatus reflecting one aspect of the present invention is configured to edit a display screen in which input of setting of a setting item is accepted and comprises a hardware processor.

The display screen includes a first screen including a first number of objects for accepting inputs of two or more setting items and a second screen including a second number of objects for accepting input of at least one setting item.

The hardware processor has the display screen switched from the first screen to the second screen when an operation by a user onto the display screen is a prescribed operation to select an object in the first screen while the first screen is shown as the display screen and has the selected object arranged in the switched second screen.

To achieve at least one of the abovementioned objects, according to an aspect of the present invention, a computer-readable storage medium reflecting one aspect of the present invention has a program stored thereon, the program having a computer perform a method of editing a screen in which input of setting of a setting item is accepted.

The method includes accepting an operation by a user onto a display screen. The screen includes a first screen including a first number of objects for accepting inputs of two or more setting items and a second screen including a second number of objects for accepting input of at least one setting item. The method further includes switching the display screen from the first screen to the second screen when the accepted operation by the user is a prescribed operation to select an object in the first screen while the first screen is shown as the display screen and arranging the selected object in the switched second screen.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing a schematic configuration of a system 1 according to an embodiment.

FIG. 2 is a diagram schematically showing one example of a hardware configuration of an information processing terminal 200 according to the embodiment.

FIG. 3 is a diagram schematically showing one example of a hardware configuration of an image forming apparatus 100 according to the embodiment.

FIG. 4 is a diagram showing a functional configuration of a printer driver 400 according to the embodiment.

FIG. 5 is a diagram illustrating normal screen setting data and user setting screen data according to the embodiment.

FIG. 6 is a diagram schematically showing one example of a basic normal setting screen according to the embodiment.

FIG. 7 is a diagram showing one example of the normal setting screen according to the embodiment.

FIG. 8 is a diagram illustrating a preliminary selection operation according to the embodiment.

FIGS. 9 and 10 are diagrams each illustrating a formal selection operation according to the embodiment.

FIG. 11 is a diagram illustrating an example of addition of an object to the user setting screen according to the embodiment.

FIG. 12 is a flowchart of processing according to the embodiment.

FIG. 13 is a diagram showing one example of a functional configuration for editing the user setting screen of the image forming apparatus according to the embodiment.

### DETAILED DESCRIPTION OF EMBODIMENTS

Hereinafter, one or more embodiments of the present invention will be described with reference to the drawings. However, the scope of the invention is not limited to the disclosed embodiments.

An embodiment of an information processing apparatus will be described below with reference to the drawings. The same elements and components have the same reference numerals allotted in the description below and their labels and functions are also the same. Therefore, description thereof will not be repeated.

<Overview of Embodiment>

An information processing apparatus edits a screen for accepting input of setting of a setting item. The information processing apparatus may include a general-purpose computer. The setting item is provided for each type of various setting contents such as a value and a condition for an application program included in the information processing apparatus. Such an application program may include various drivers such as a printer driver.

The information processing apparatus includes an interface which accepts an operation by a user onto a display screen and a control unit which controls the information processing apparatus. The interface may include a touch panel or a touch pad. The touch pad performs a function to receive motion of a user input onto the information processing apparatus. A surface of the touch pad may be separate from a display.

The display screen includes a first screen including a first number of objects for accepting inputs of two or more setting items and a second screen including a second number of objects. The control unit includes switching means for switching the display screen from the first screen to the second screen when an operation by a user accepted by the interface is a prescribed operation to select an object in the first screen while the first screen is shown as the display screen and arrangement means for arranging the selected object in the switched second screen.

When a prescribed operation to select an object in the first screen is performed as described above, the control unit has the display screen switched. Thus, the user is not required to perform an operation to move an object out of the screen for switching the screen as in Japanese Laid-Open Patent Publication No. 2015-46123.

Terms below are used in this embodiment.

A “device” refers to an apparatus which operates in coordination with an information processing terminal such as peripherals of a PC, and includes various apparatuses such as a printer, a display, a keyboard, and a communication instrument, however, it is not limited thereto.

A “drive?” includes a program for exchanging data between an operating system (OS) of an information processing terminal and a device in order to enable the coordinated operation above or data or both of the program and the data.

A “setting item” refers to a type of setting contents such as a value and a condition set for the driver.

A “normal setting screen” represents one embodiment of the “first screen.” The “normal setting screen” includes a screen in which objects of a plurality of setting items which can be set under normal conditions (by default) for the driver are arranged.

A “user setting screen” represents one embodiment of the “second screen.” The “user setting screen” includes a screen where an object of a setting item preferred by a user is arranged.

An “object” refers to a component which implements a UI for input of setting contents of a setting item in the normal setting screen or the user setting screen. This component includes a character string, an image such as graphics (a mark and a picture), or an image of combination thereof. An identifier of an object, arrangement data indicating a position (a coordinate) on a screen, and a function performed as a result of execution of a program code are associated with the “object”. Though an associated function includes a function to input setting contents of a setting item of the object to an information processing terminal 200 (more specifically, a driver), a type of the associated function is not limited thereto.

A “preliminary selection operation” refers to an operation to preliminarily select a candidate for an object to be arranged in the user setting screen, and includes, for example, a “click” operation. A type of the preliminary selection operation is not limited to the click operation.

A “formal selection operation” refers to an operation to formally select a candidate for a preliminarily selected object. Unlike a type of the preliminary selection operation, the formal selection operation includes, for example, a “drag (drag and drop)” operation or a “double-click” operation or a “press-and-hold” operation. A type of the formal selection operation is not limited thereto.

“Edition” includes change in arrangement of an object (addition, deletion, and movement of an object) of a setting item in the user setting screen.

The “drag operation” refers to an operation to move an object within a screen (a touch panel) by changing a position of contact with the screen while a user remains selecting an image of the object by an operation to touch the screen (touch panel) with a pointing member. The pointing member may include a finger or a dedicated pen.

“Drop” refers to an operation to stop touching an object in the drag operation. Drop represents one embodiment of end of the drag operation. Drop processing for canceling a selected state of an object is performed at a position and the drag operation ends.

<A. Configuration of Network System>

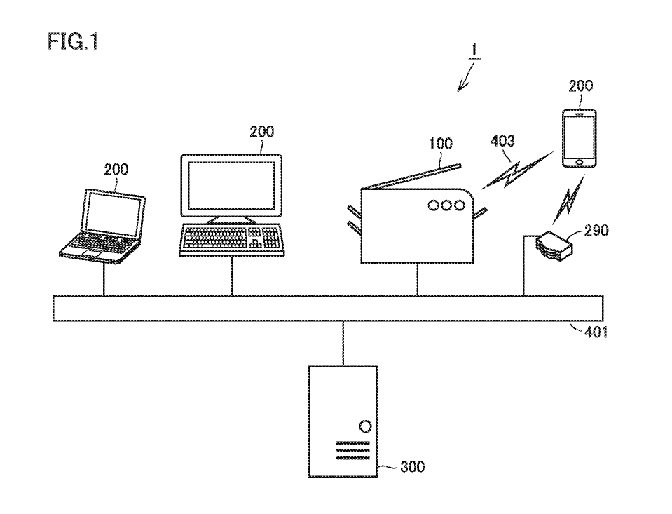

FIG. 1 is a diagram showing a schematic configuration of a system 1 according to an embodiment.

Referring to FIG. 1, system 1 includes an image forming apparatus 100, at least one information processing terminal 200, and a server 300. In system 1, image forming apparatus 100 and information processing terminal 200 communicate with each other through a network 401 or 403. Network 401 includes a local area network (LAN) or a global network. Network 403 may include short-distance wireless communication such as near field communication (NFC).

Server 300 may include, for example, a cloud server. Server 300 communicates with image forming apparatus 100 or information processing terminal 200 through network 401 or 403. For example, server 300 functions to manage image forming apparatus 100 or to distribute an application for utilizing image forming apparatus 100 to information processing terminal 200.

Information processing terminal 200 is configured comparably to a computer, and includes an apparatus such as a personal computer, a tablet computer, or a smartphone including a memory (storage) which stores at least a program, a processor which executes a program, a communication circuit, and an instruction input device. Information processing terminal 200 may be connected to network 401 through a relay 290 such as a router.

System 1 may be provided with a plurality of image forming apparatuses 100. System 1 may be provided with single information processing terminal 200.

In system 1, information processing terminal 200 represents one embodiment of the “information processing apparatus.” In information processing terminal 200 in one embodiment, an installed OS executes various applications such as a printer driver to thereby output a print job to image forming apparatus 100. The print job includes setting contents of a setting item for a print condition (for example, whether or not to “staple” and various values for “color/monochrome”). The setting contents may include normal (default) setting contents accepted by the printer driver or setting contents which are different from the normal setting contents and preferred by a user. The printer driver sets the accepted setting contents in a print job. Image forming apparatus 100 executes a print job from information processing terminal 200 (more specifically, from the printer driver). A printer of image forming apparatus 100 is controlled in accordance with the setting contents in the print condition included in the print job. Image forming apparatus 100 thus performs print processing.

<B. Hardware Configuration of Information Processing Terminal 200>

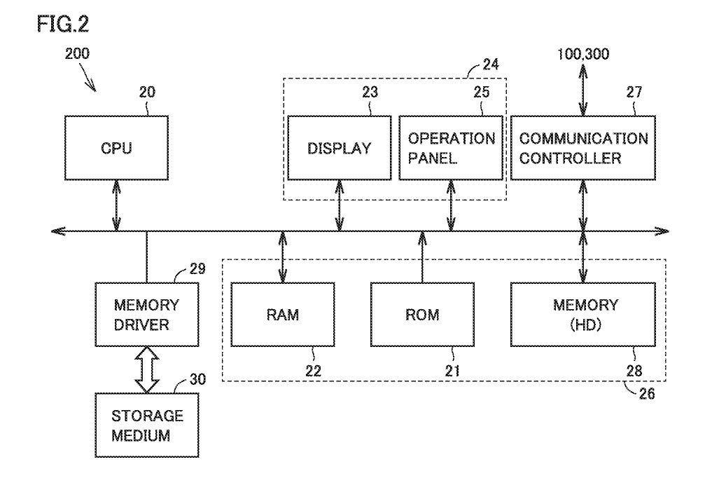

FIG. 2 is a diagram schematically showing one example of a hardware configuration of information processing terminal 200 according to the embodiment. Referring to FIG. 2, information processing terminal 200 includes a central processing unit (CPU) 20, a display 23, an operation panel 25 operated by a user to input information into information processing terminal 200, a storage portion 26, a communication controller 27, and a memory driver 29. Though display 23 may include a liquid crystal display driven in accordance with representation control data 461 (which will be described later), a type of the display is not limited to the liquid crystal display.

Memory driver 29 includes a circuit which reads a program or data from an externally attached storage medium 30 and a circuit which writes data into storage medium 30.

Storage portion 26 includes a read only memory (ROM) 21 which stores a program executed by CPU 20 and data, a random access memory (RAM) 22, and a memory 28 including a hard disk apparatus. Communication controller 27 includes a communication circuit such as a network interface card (NIC) or a LAN circuit for communication with another information processing terminal 200 or image forming apparatus 100 or server 300.

CPU 20 performs operation processing for control of operations by information processing terminal 200 as a whole. A main storage including ROM 21 and RAM 22 functions as a memory configured to temporarily store information in operation processing by CPU 20. The hard disk apparatus as memory 28 functions as a storage which plays a role auxiliary to the main storage. The auxiliary storage is normally configured to be able to save information for a long time. Various computer programs such as various applications, a printer driver, and a facsimile driver may be stored in the auxiliary storage.

In information processing terminal 200, operation panel 25 or a touch panel implemented by display 23 and operation panel 25 as being integrated may be provided as an input apparatus 24. Input apparatus 24 may further include a keyboard and a mouse, although they are not shown. Input apparatus 24 represents one example of an input interface included in information processing terminal 200, and accepts various inputs to information processing terminal 200 from a user.

An output apparatus of information processing terminal 200 such as display 23 is configured to externally output information on a result of processing by CPU 20. The input apparatus and the output apparatus of information processing terminal 200 described above may be implemented by a communication interface for communication with external equipment such as a LAN card.

CPU 20 executes an application program corresponding to various drivers such as a printer driver and a facsimile driver. The application program and associated data are stored, for example, in the auxiliary storage. CPU 20 reads an application program from the auxiliary storage into the main storage as necessary and executes the application program. In an example of a printer driver, operation processing in connection with setting of a setting item for a print condition is performed. In an example of a facsimile driver, processing in connection with setting of various setting items (resolution) is performed.

<C. Hardware Configuration of Image Forming Apparatus 100>

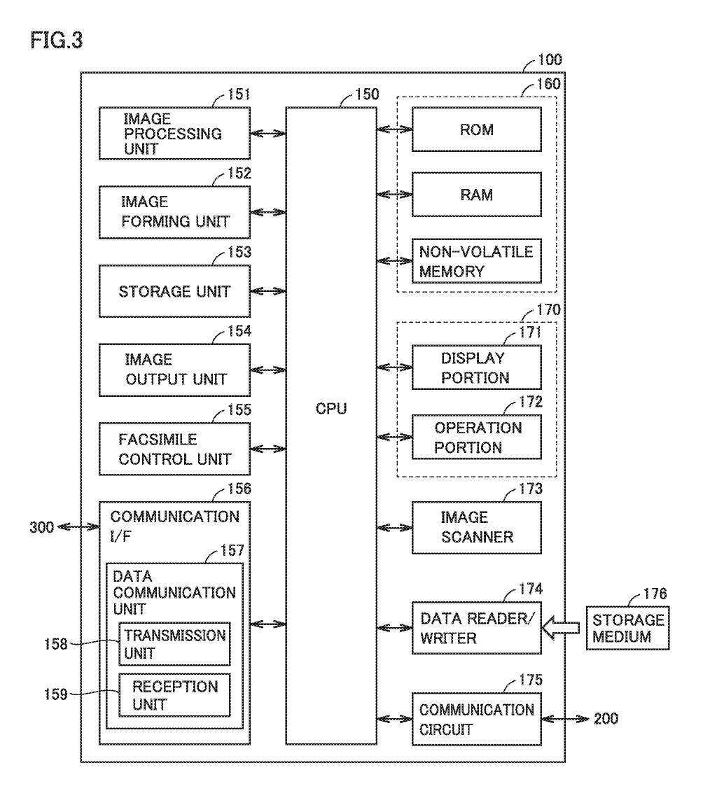

FIG. 3 is a diagram schematically showing one example of a hardware configuration of image forming apparatus 100 according to the embodiment. Referring to FIG. 3, image forming apparatus 100 is exemplified as a printer or a copying machine or a multi-function peripheral (MFP) which is combination thereof. Image forming apparatus 100 includes a CPU 150, a storage portion 160 which stores a program and data, an information input and output portion 170, a communication interface (I/F) 156 for communication with server 300 through network 401 or relay 290, a communication circuit 175 for communication with information processing terminal 200 through network 401 or 403, and various processing units.

Storage portion 160 includes a ROM, a RAM, and a non-volatile memory which store a program executed by CPU 150 and data. The RAM also serves as a work area in execution of a program by CPU 150.

Input and output portion 170 includes a display portion 171 including a display and an operation portion 172 operated by a user to input information into image forming apparatus 100. Input and output portion 170 may be provided as a touch panel implemented by display portion 171 and operation portion 172 as being integrated.

Communication I/F 156 includes a circuit such as an NIC. Communication I/F 156 includes a data communication unit 157 for communication with an external apparatus including server 300 through a network. Data communication unit 157 includes a transmission unit 158 which transmits data to an external apparatus including server 300 through a network and a reception unit 159 which receives data from an external apparatus including server 300 through a network.

Communication circuit 175 includes a communication circuit such as LAN or NFC for communication with information processing terminal 200.

The various processing units above include an image processing unit 151, an image forming unit 152, a storage portion 153 such as a hard disk which stores various types of data including image data, an image output unit 154 which controls a not-shown printer, a facsimile control unit 155 which controls a not-shown facsimile circuit, an image scanner 173 which optically scans a document to obtain image data, and a data reader/writer 174 to/from which an external storage medium is attached/detached.

Image output unit 154 drives a printer with a print job received from information processing terminal 200. Data reader/writer 174 includes a circuit which reads a program or data from an attached external storage medium 176 and a circuit which writes data into external storage medium 176.

Various types of processing described in this disclosure are performed, for example, by execution of a computer program as appropriate by CPU 20 or CPU 150. In one embodiment, the various types of processing are not limited to those performed by a program executed by the CPU. For example, the various types of processing may be implemented by a circuit such as an application specific integrated circuit (ASIC) or a field-programmable gate array (FPGA) or may be implemented by a combination of a program and a circuit.

<D. Functional Configuration of Printer Driver>

A printer driver is exemplified in the description below as a driver of information processing terminal 200. An embodiment below can similarly be applied also to other types of drivers such as a facsimile driver. Edition of a user setting screen for the printer driver will be described as one embodiment of edition.

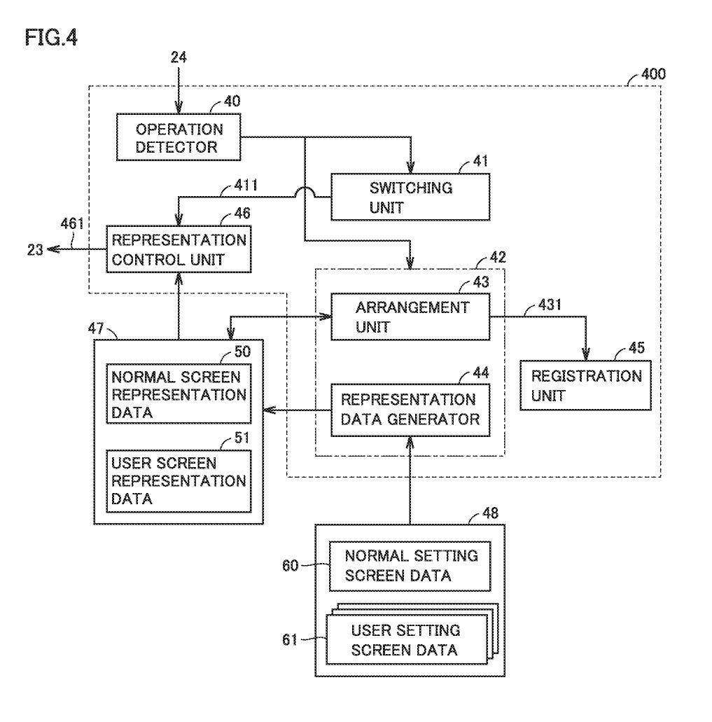

FIG. 4 is a diagram showing a functional configuration of a printer driver 400 according to the embodiment. Printer driver 400 corresponds to an application program stored in storage portion 26 of information processing terminal 200 as one embodiment. In another embodiment, printer driver 400 may be implemented by combination of a program and a circuit (an ASIC or an FPGA) or by a circuit.

FIG. 4 shows printer driver 400 and peripherals thereof. Printer driver 400 includes an operation detector 40, a switching unit 41, an edition unit 42 including an arrangement unit 43 and a representation data generator 44, a registration unit 45, and a representation control unit 46. The peripherals include a memory 47 for representation and a screen data memory 48 as one embodiment.

Screen data memory 48 corresponds to a non-volatile storage area of storage portion 26. Screen data memory 48 stores normal setting screen data 60 and user setting screen data 61 corresponding to at least one user.

Memory 47 for representation represents one embodiment of an image memory and stores normal screen representation data 50 for showing the normal setting screen on a screen of display 23 (which is also referred to as a display screen) and user screen representation data 51 for showing the user setting screen on the screen of display 23. Normal screen representation data 50 and user screen representation data 51 may include, for example, a position of each object and bit map data of the object. A data format is not limited as such.

Representation control unit 46 generates representation control data 461 from normal screen representation data 50 and user screen representation data 51 in memory 47 for representation, and outputs generated representation control data 461 to display 23. Display 23 thus shows the normal setting screen or the user setting screen by being driven in accordance with representation control data 461.

Operation detector 40 analyzes contents of an operation by a user accepted by input apparatus 24 and detects a type of the operation by the user based on a result of analysis. In one embodiment, operation detector 40 detects whether or not the operation by the user is a prescribed operation based on the result of analysis. The prescribed operation may include a formal selection operation.

Switching unit 41 makes determination as to an output from operation detector 40 and outputs a switch command 411 based on a result of determination to representation control unit 46. Switch command 411 is a command for switching the display screen, and representation control unit 46 controls display 23 so as to have the screen switched in accordance with switch command 411.

Edition unit 42 edits the user setting screen. Specifically, arrangement unit 43 in edition unit 42 changes user screen representation data 51 in memory 47 for representation such that arrangement of an object is changed in the user setting screen in accordance with an output from operation detector 40. For example, when operation detector 40 detects a formal selection operation (a drag and drop operation), arrangement unit 43 generates arrangement information 431 from the output from operation detector 40, and outputs the arrangement information to registration unit 45. Arrangement information 431 includes an identifier and a position of a selected object.

During edition, representation data generator 44 in edition unit 42 changes (rewrites) normal screen representation data 50 or user screen representation data 51 in memory 47 for representation such that arrangement of an object in the display screen changes with movement (change) of a position of contact detected by operation detector 40. A position of an object shown in the user setting screen on display 23 can thus be changed, for example, in coordination with a drag operation by the user (for example, in real time).

When it is determined that a drag operation as the formal selection operation has ended, that is, a drop operation has been performed, based on an output from operation detector 40, arrangement unit 43 generates arrangement information 431 from the output from operation detector 40 and outputs the arrangement information to registration unit 45. Arrangement information 431 includes a position of start and a position of end (a drop position) of drag on the display screen, of the object formally selected on the display screen.

Registration unit 45 registers in (adds to) user setting screen data 61, the formally selected object by changing user setting screen data 61 in screen data memory 48 in accordance with arrangement information 431 from arrangement unit 43. Details of registration processing will be described later.

<E. Screen Data and Registration Processing>

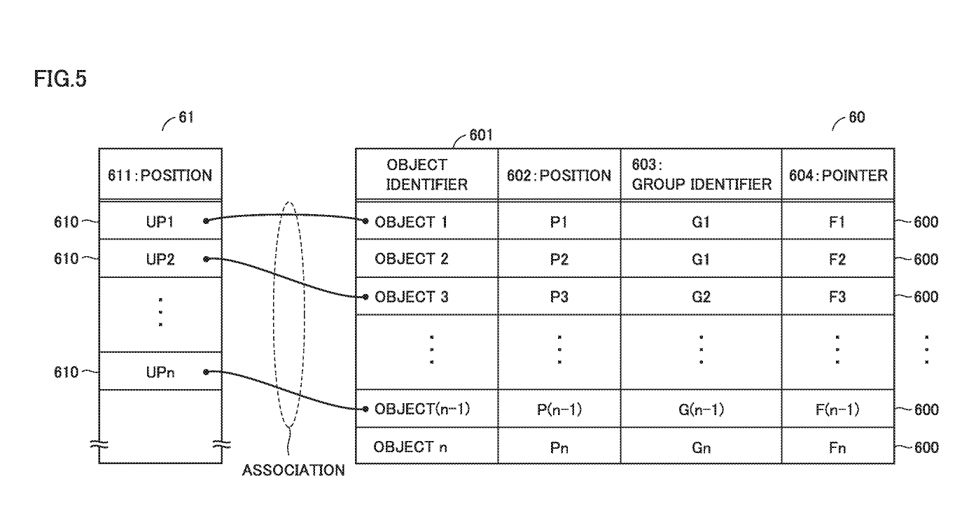

FIG. 5 is a diagram illustrating normal screen setting data and user setting screen data according to the embodiment. Referring to FIG. 5, normal setting screen data 60 includes a record 600 in association with each of setting items in the normal setting screen. Record 600 includes an object identifier 601, a position 602 (for example, a coordinate value) of the object in the normal setting screen, an identifier 603 of a group to which a setting item of the object belongs and which will be described later, and an associated function pointer 604. Associated function pointer 604 is expressed by a value indicating information on an associated function of each setting item (setting contents in an example of an input function) stored in storage portion 26. For example, a value indicated by pointer 604 includes an address where information on the associated function is stored.

User setting screen data 61 includes a record 610 including a position (for example, a coordinate value) 611 on the user setting screen corresponding to each object arranged on that screen. Record 610 is associated (linked) to any record 600 in normal setting screen data 60. In this embodiment, an object arranged on the user setting screen is at least one object selected from objects in the normal setting screen. Therefore, record 600 in normal setting screen data 60 of each object is associated with record 610 of the object in user setting screen data 61. Printer driver 400 can thus obtain, for each object in the user setting screen, object identifier 601 of that object, group identifier 603, and associated function pointer 604 from record 600 associated with record 610 of that object.

Registration unit 45 performs registration processing for registering (adding) record 610 in user setting screen data 61. In the registration processing, registration unit 45 registers (adds) record 610 of an object 11 of a setting item selected by the formal selection operation in user setting screen data 61. Specifically, registration unit 45 generates record 610 which includes an end position in the display screen indicated by arrangement information 431 output from arrangement unit 43 as a position 611 and newly has the record stored in user setting screen data 61. Registration unit 45 retrieves record 600 having position 602 corresponding to a start position in the display screen indicated by arrangement information 431 from normal setting screen data 60 based on the start position. Registration unit 45 associates retrieved record 600 with record 610 newly stored in user setting screen data 61. Record 610 of object 11 of the formally selected setting item can thus be registered in user setting screen data 61.

<F. Normal Setting Screen>

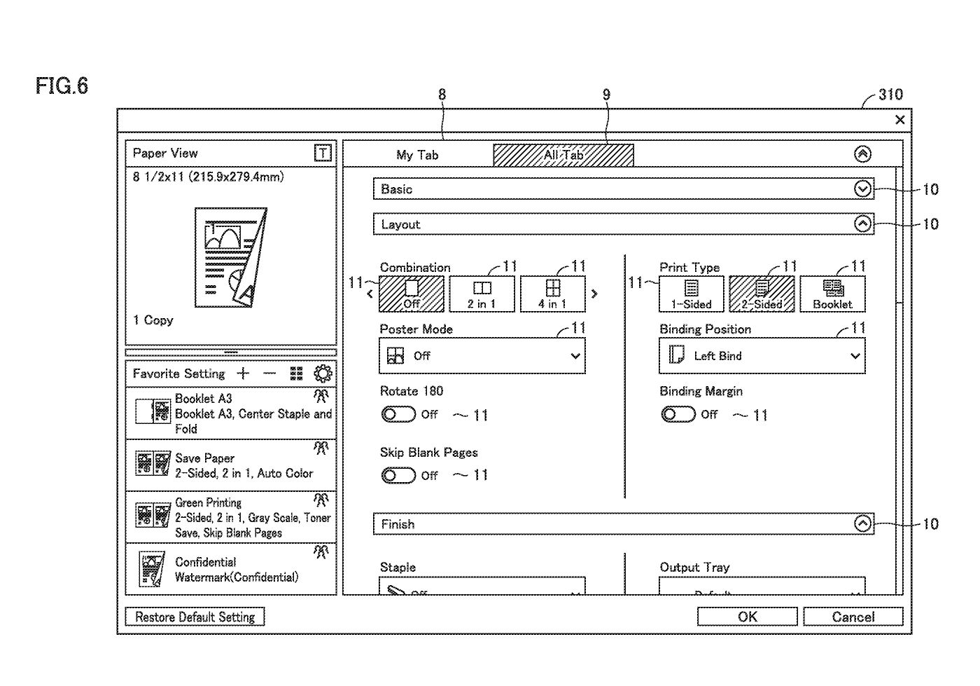

FIG. 6 is a diagram schematically showing one example of a basic normal setting screen according to the embodiment. A screen shown by means of printer driver 400 includes a tab 8 and a tab 9. Printer driver 400 shows one of tab 8 and tab 9 in an emphasized manner. Printer driver 400 can thus give a notification that a screen being shown is a user setting screen 320 (which will be described later) by showing tab 8 in the emphasized manner and can give a notification that a screen being shown is a normal setting screen 310 by showing tab 9 in the emphasized manner.

Normal setting screen 310 in FIG. 6 includes an object 10 corresponding to a group including at least one setting item. Object 10 shows a name of a corresponding group. In normal setting screen 310 in FIG. 6, when object 10 having a group name ‘Layout’ is operated, printer driver 400 has a list of objects shown, the list of objects showing names of setting items belonging to the group ‘Layout’. Specifically, when operation detector 40 detects a click operation of ‘Layout’ object 10 based on contents of an operation accepted by input apparatus 24, representation data generator 44 generates representation data of a pull-down menu in FIG. 6 from normal setting screen data 60 in screen data memory 48 based on an output from operation detector 40 and rewrites normal screen representation data 50 in memory 47 for representation with the generated representation data. A list of objects 11 showing names of a plurality of setting items included in the group ‘layout’ is thus shown on normal setting screen 310 (see FIG. 6). Object 11 is not limited to a manner of representation in this pull-down menu, and it may be shown, for example, in a pull-up menu. Though the name of the group is shown as being superimposed on object 10 and a name of a setting item is shown as being superimposed on object 11, limitation to the name is not intended, and a picture or combination of them may be shown. The normal setting screen may be constituted of a plurality of screens.

<G. Another Example of Normal Setting Screen>

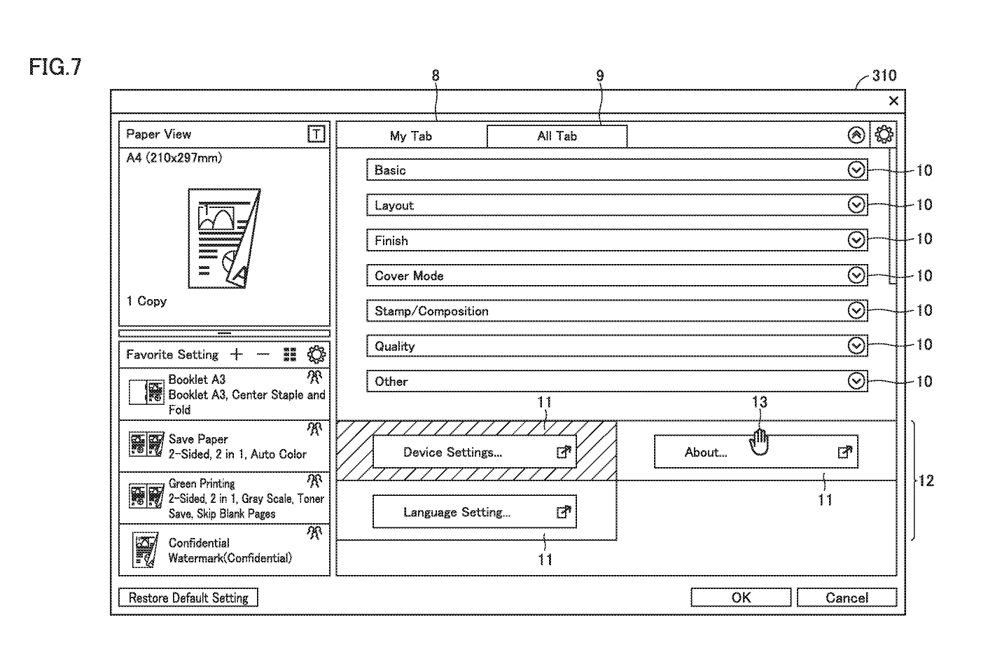

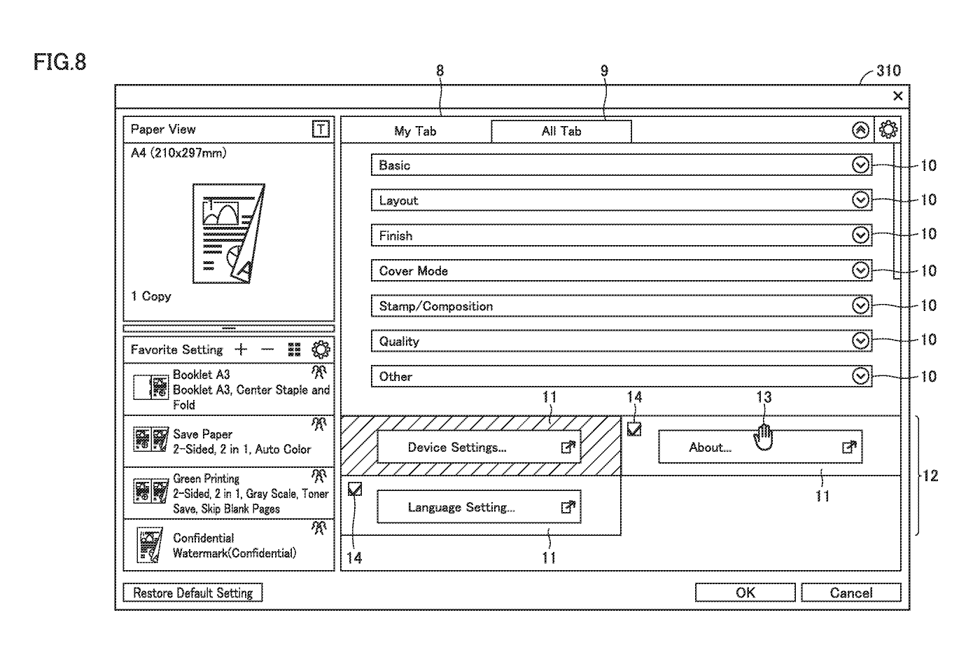

FIG. 7 is a diagram illustrating one example of the normal setting screen according to the embodiment. FIG. 8 is a diagram illustrating a preliminary selection operation according to the embodiment. Referring to FIG. 7, normal setting screen 310 includes a list 12 of objects 11. Specifically, when object 10 having a group name “Other” in the list of objects 10 of groups is clicked in normal setting screen 310, objects 11 corresponding to respective setting items included in the group ‘Other’ are shown in list 12. When a user points list 12 with a mouse as input apparatus 24, a mark 13 (for example, a hand mark) is shown at a position of the mouse. Specifically, operation detector 40 detects a position of the mouse based on operation contents accepted by input apparatus 24 and representation data generator 44 changes normal screen representation data 50 such that mark 13 is superimposed on the position of the mouse based on an output from operation detector 40. Mark 13 is thus shown in list 12 in normal setting screen 310 on display 23 as in FIG. 7.

<H. Preliminary Selection Operation>

FIG. 8 is a diagram illustrating a preliminary selection operation according to the embodiment. A preliminary selection operation will be described with reference to normal setting screen 310 in FIG. 8. When a user clicks object 11 in list 12 in FIG. 8, object 11 is preliminarily selected as a candidate for object 11 to be arranged in user setting screen 320.

Specifically, operation detector 40 detects a position of click based on operation contents accepted by input apparatus 24 and representation data generator 44 changes normal screen representation data 50 such that a mark 14 is superimposed on object 11 corresponding to a detected position based on an output from operation detector 40. In normal setting screen 310 in FIG. 8, an operation to preliminarily select objects 11, for example, of two setting items of “About” and “Language Setting” is performed and mark 14 indicating a preliminarily selected state is provided to each object 11.

The user can quit (cancel) selection of object 11 as a candidate by again performing an operation to preliminarily select object 11 which was preliminarily selected (that is, to which mark 14 was provided). When selection as the candidate is canceled, mark 14 is erased.

<I. Formal Selection Operation>

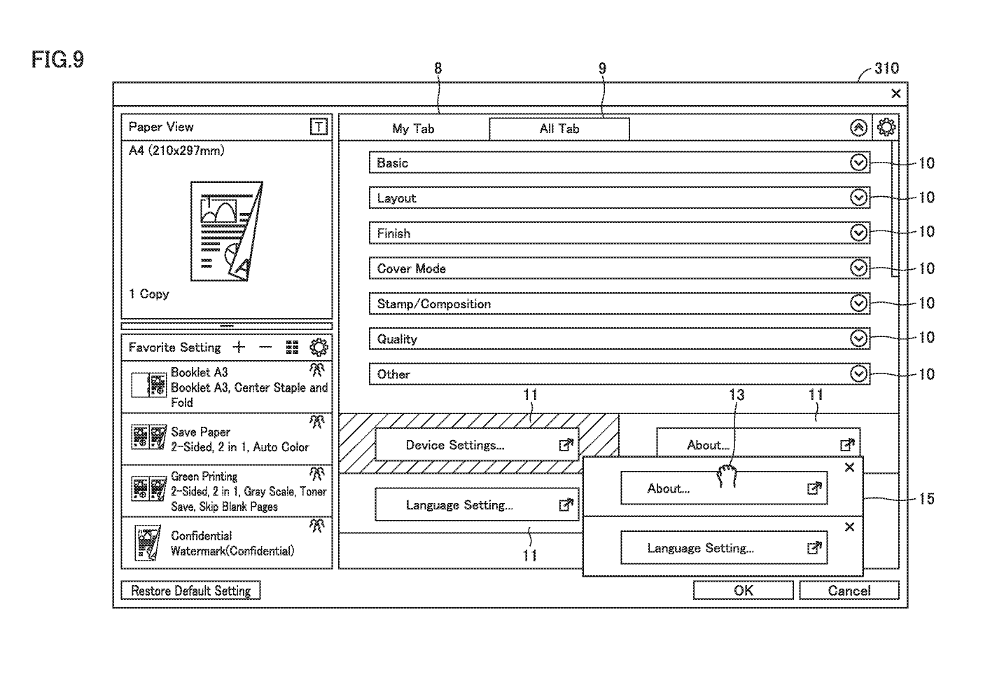

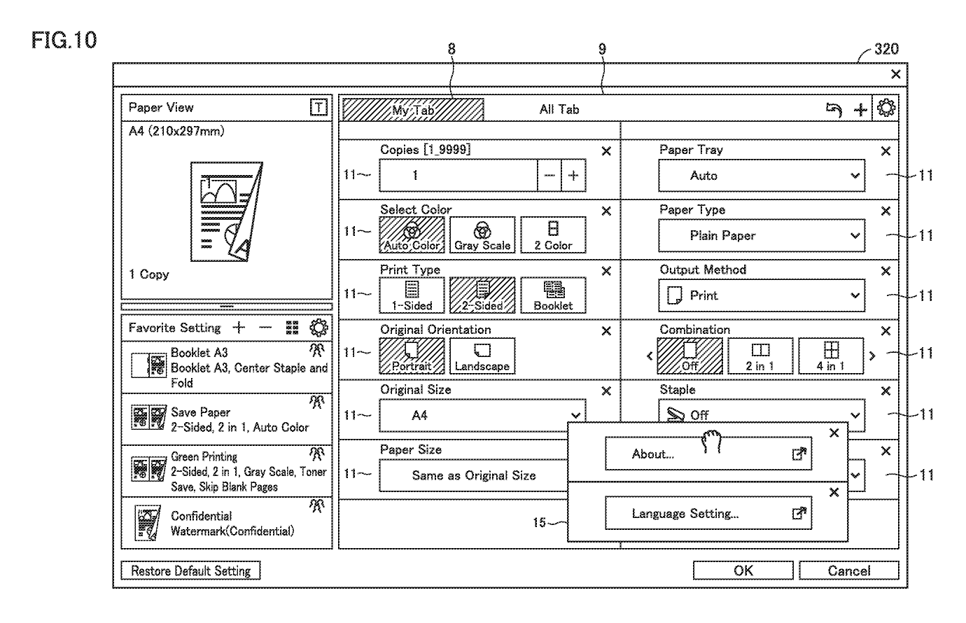

FIGS. 9 and 10 are diagrams each illustrating a formal selection operation according to the embodiment. Referring to normal setting screen 310 in FIG. 9, when the user performs a formal selection operation, a copy object 15 which is a copy image of objects 11 of the two setting items preliminarily selected in FIG. 8 is moved over the screen in accordance with a drag operation by the user.

Specifically, when operation detector 40 detects a formal selection operation based on operation contents accepted by input apparatus 24, representation data generator 44 generates copy object 15 of object 11 preliminarily selected as the candidate based on an output from operation detector 40 and changes normal screen representation data 50 such that copy object 15 is superimposed. In normal setting screen 310 in FIG. 9, for example, copy object 15 constituted of two objects 11 of “About” and “Language Setting” preliminarily selected as candidates is superimposed on normal setting screen 310. Mark 13 is shown for copy object 15 at a position where the mouse is placed.

Copy object 15 may be generated for each object 11 preliminarily selected as a candidate.

In succession, when the user positions the mouse over copy object 15 and starts a drag operation in normal setting screen 310, the screen on display 23 is switched from normal setting screen 310 to user setting screen 320 in FIG. 10.

Specifically, when operation detector 40 detects a prescribed operation (a drag operation) in normal setting screen 310 based on operation contents accepted by input apparatus 24, representation data generator 44 changes user screen representation data 51 in memory 47 for representation such that copy object 15 is superimposed on a position of start of the drag operation based on an output from operation detector 40. Switching unit 41 outputs switch command 411 to representation control unit 46 based on an output indicating detection of the drag operation by operation detector 40. Representation control unit 46 thus switches data to be read from memory 47 for representation from normal screen representation data 50 to user screen representation data 51 and representation control unit 46 outputs representation control data 461 based on user screen representation data 51 to display 23. The screen on display 23 thus switches from normal setting screen 310 in FIG. 9 to user setting screen 320 in FIG. 10. Since copy object 15 is shown at a position the same as the position immediately before switching of the screen also in switched user setting screen 320, the user can be prevented from losing track of copy object 15 on the screen even though the screen is switched.

<J. Addition of Object>

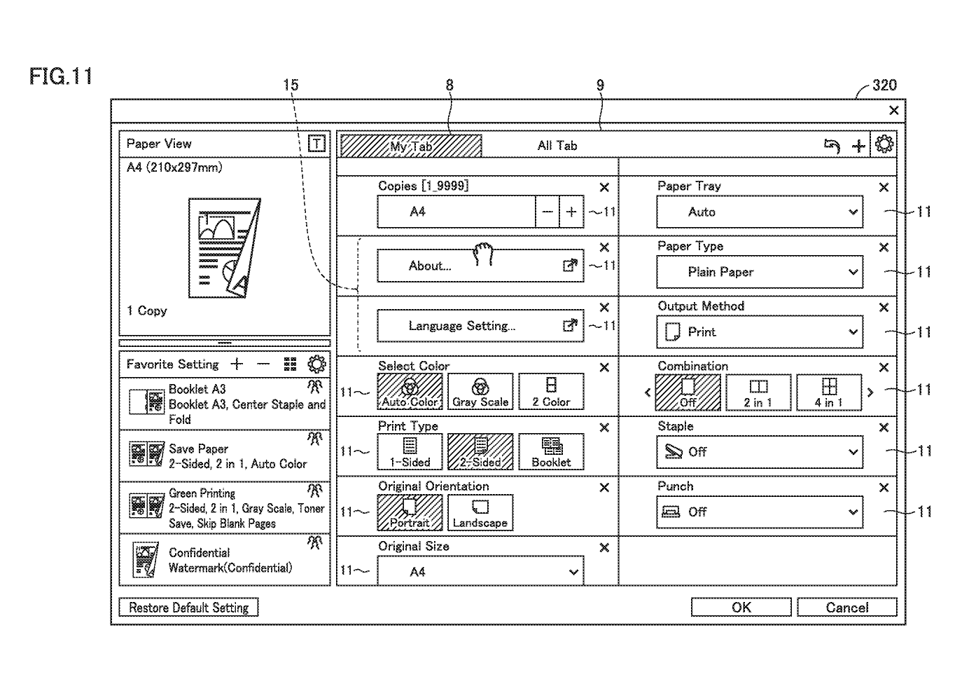

FIG. 11 is a diagram illustrating an example of addition of an object to the user setting screen according to the embodiment. When the user performs an operation to drop copy object 15 which has been dragged by the user in user setting screen 320 by the drag operation which is the formal selection operation described above, that is, when the user quits the drag operation, copy object 15 is arranged at a drop position (a position of end of the drag operation) (see FIG. 11).

Specifically, when operation detector 40 detects the drop operation (end of the drag operation) and the drop position in the display screen based on operation contents accepted by input apparatus 24, arrangement unit 43 changes user screen representation data 51 in memory 47 for representation such that copy object 15 is arranged at the drop position based on an output from operation detector 40. The screen on display 23 is thus changed from the screen at the time of start of the drag operation in FIG. 10 to the screen at the time of the drop operation (end of the drag operation) in FIG. 11. Arrangement unit 43 outputs arrangement information 431 on copy object 15 (preliminarily selected object 11) to registration unit 45.

In user setting screen 320 in FIG. 11, positions of original objects 11 arranged at the drop position are changed to positions below a position of addition of copy object 15 such that copy object 15 is added at the drop position (which is also referred to as arrangement change).

<K. Processing Flowchart>

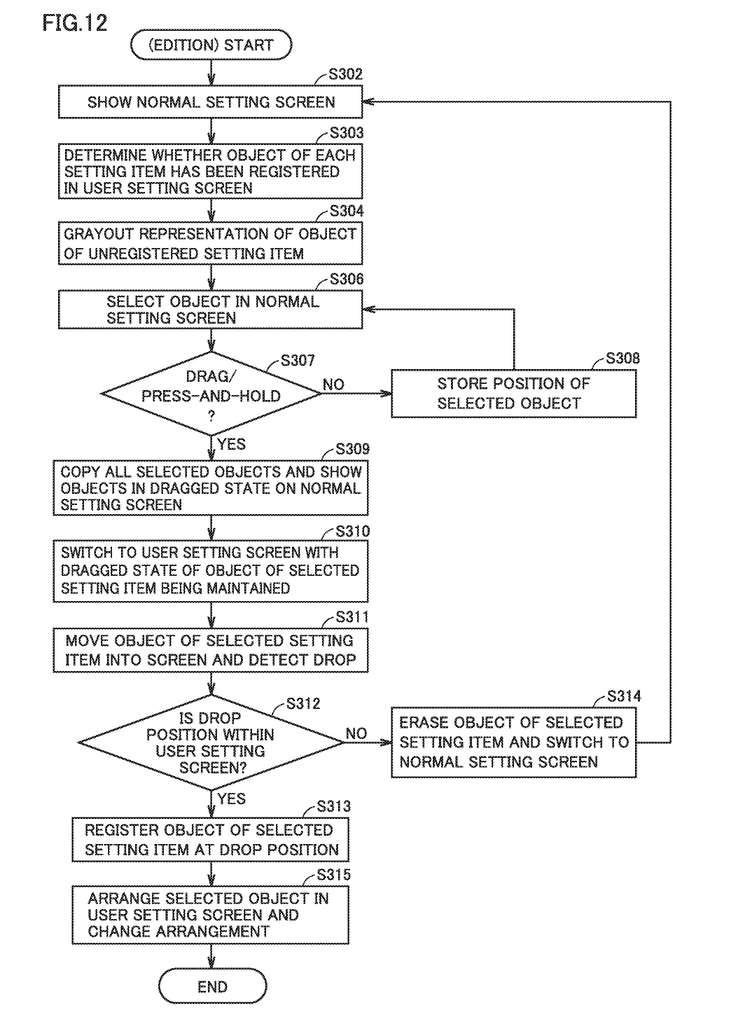

FIG. 12 is a flowchart of processing according to the embodiment. This flowchart is stored in advance as a program in a non-volatile area in storage portion 26. CPU 20 reads a program from storage portion 26 and executes the program. Processing for edition of user setting screen 320 and processing for registration of user setting screen data 61 are thus performed.

In the embodiment, for brevity of the description, it is assumed that normal setting screen 310 and user setting screen 320 are identical in size (shape) and objects 11 are also identical in size (shape). Therefore, a position of detection by operation detector 40 on the display screen is indicated by a value common to both of normal setting screen 310 and user setting screen 320 (for example, a coordinate value). If normal setting screen 310 and user setting screen 320 are different in size from each other, a position of detection by operation detector 40 may be converted by prescribed calculation in accordance with a size of each of normal setting screen 310 and user setting screen 320.

When a user initially logs into information processing terminal 200, CPU 20 obtains a user ID (an identifier). The user ID includes, for example, a log-in ID. When CPU 20 accepts an instruction to edit user setting screen 320 from the user through input apparatus 24, it starts processing in FIG. 12.

In this embodiment, for example, the user can give an instruction for edition of user setting screen 320 to information processing terminal 200 by clicking an edit button shown on the screen. While the processing in FIG. 12 is being performed, CPU 20 (more specifically, printer driver 400) does not accept input of setting of a print setting item.

When the processing is started, display 23 shows, for example, normal setting screen 310 in FIG. 7 (step S302).

Printer driver 400 determines whether or not an object of each setting item in normal setting screen 310 has been registered in the user setting screen (step S303).

Specifically, printer driver 400 retrieves user setting screen data 61 corresponding to the user from screen data memory 48 based on the log-in ID. Printer driver 400 determines whether or not each record 600 in normal setting screen data 60 is associated with record 610 in retrieved user setting screen data 61 (step S303).

Printer driver 400 changes a manner of representation of an object in normal setting screen 310 of each record 600 determined as being not associated with record 610 to a prescribed manner of representation different from that of another object (for example, grayout representation) in order to show that selection of the object as a candidate is not permitted (an operation for preliminary selection thereof is prohibited) (step S304).

Specifically, printer driver 400 outputs position 602 of each record 600 determined as being not associated with record 610 to representation data generator 44. Representation data generator 44 changes bit map data of an object corresponding to position 602 to grayout among objects in normal screen representation data 50 in memory 47 for representation (see FIG. 7). In FIG. 7, for example, “Device Setting” object 11 is grayed out. The manner of representation is not limited to grayout so long as a notification that a selection operation is not permitted can be given.

Printer driver 400 controls input apparatus 24 or operation detector 40 so as to prohibit acceptance of an operation to select grayed-out object 11. Thus, even when a user performs an operation to select (click or drag) grayed-out object 11 in normal setting screen 310, printer driver 400 does not accept (or ignores) those operation contents. Therefore, in this case, subsequent processing is not performed.

When the user performs an operation to select object 11 different from grayed-out object 11 (step S306), operation detector 40 determines whether or not operation contents indicate an operation to formally select object 11 of the setting item in normal setting screen 310 based on an output from input apparatus 24 (step S307).

When operation detector 40 detects the formal selection operation (YES in step S307), transition to step S309 which will be described later is made. When operation detector 40 does not detect a formal selection operation, that is, detects a preliminary selection operation (NO in step S307), representation data generator 44 extracts a position on the display screen of object 11 preliminarily selected in step S306 from an output from operation detector 40 and has the position stored (step S308). Mark 14 (see FIG. 8) is shown on object 11 of the preliminarily selected setting item on normal setting screen 310 on display 23. Thereafter, the process returns to step S306. Representation data generator 44 thus has the position of object 11 of at least one setting item preliminarily selected as the candidate by the user stored.

In step S307, operation detector 40 detects whether or not movement of a position of touch in the selection operation, that is, the drag operation, satisfies a prescribed condition. When operation detector 40 determines that the selection operation satisfies the prescribed condition, switching unit 41 outputs switch command 411 so as to switch the screen on display 23 from normal setting screen 310 to user setting screen 320.

The prescribed condition described above may include such a condition that a speed since start of movement of a touch position has exceeded a prescribed speed. Alternatively, the prescribed condition may include such a condition that a direction of movement of the touch position indicates a prescribed direction. Alternatively, the prescribed condition may include combination of these conditions.

When the formal selection operation is detected (YES in step S307), representation data generator 44 generates in step S309, copy object 15 of object 11 of at least one candidate selected by the preliminary selection operation. Generated copy object 15 is shown as being moved in accordance with a drag operation by the user over normal setting screen 310 (see FIG. 8).

When or after movement is started in step S309, switching unit 41 outputs switch command 411 to representation control unit 46. The screen on display 23 thus switches from normal setting screen 310 to user setting screen 320 (see FIG. 10) (step S310). Copy object 15 is shown with a dragged state being maintained, that is, at the touch position, also in user setting screen 320 after switching of the screen.

Operation detector 40 detects a drop operation based on an output from input apparatus 24 (step S311).

When the drop operation is detected, arrangement unit 43 determines whether or not a drop position is within user setting screen 320 based on an output from operation detector 40 (step S312). Specifically, arrangement unit 43 compares the drop position detected by operation detector 40 with a threshold value and makes determination based on a result of comparison.

When arrangement unit 43 determines that the drop position is not within user setting screen 320, that is, the drop position is out of user setting screen 320 (NO in step S312), the selection operation is canceled and display 23 is switched to normal setting screen 310 (step S314).

Specifically, in cancellation, representation data generator 44 erases all stored positions of candidate objects. Switching unit 41 outputs switch command 411 to representation control unit 46. Thereafter, the process returns to step S302. In step S302, representation control unit 46 generates representation control data 461 in accordance with normal screen representation data 50 from memory 47 for representation in accordance with switch command 411 and outputs generated representation control data 461 to display 23. Display 23 thus switches from user setting screen 320 in FIG. 10 to normal setting screen 310 (for example, FIG. 7).

When arrangement unit 43 determines that the drop position is within user setting screen 320 (YES in step S312), registration unit 45 performs the registration processing described above (step S313). In the registration processing, registration unit 45 generates record 610 including an end position (the drop position) indicated by arrangement information 431 output from arrangement unit 43 as position 611 and has the record newly stored in user setting screen data 61. Registration unit 45 associates record 600 retrieved from normal setting screen data 60 with record 610 newly stored in user setting screen data 61 based on each start position indicated by arrangement information 431 (that is, a position of each object selected in normal setting screen 310 and stored in step S308). Record 610 of each object 11 of the formally selected setting item can thus be registered in user setting screen data 61.

Based on a result of determination by arrangement unit 43, representation data generator 44 changes user screen representation data 51 so as to arrange at least one dragged object 11 (that is, copy object 15) at a position in user setting screen 320 corresponding to the drop position indicated by arrangement information 431 (step S315).

When arrangement unit 43 arranges selected object 11 at the drop position, it changes user screen representation data 51 so as to change arrangement of another object 11 on user setting screen 320 in step S315. In this arrangement change, based on an end position (the drop position) in arrangement information 431 from arrangement unit 43, registration unit 45 retrieves from user setting screen data 61, record 610 including position 611 indicating the end position. Registration unit 45 then rewrites position 611 of retrieved record 610 to a position after arrangement change. The position after arrangement change may be calculated, for example, by prescribed calculation by using the drop position and a size of copy object 15.

When operation detector 40 detects an operation to quit the process based on an output from input apparatus 24, the process in FIG. 12 ends.

According to such edition of user setting screen 320 in FIG. 12, customization by a user of a type (a type of a setting item) and arrangement of object 11 to be arranged in user setting screen 320 is facilitated, and print setting of printer driver 400 can be made in a more simplified manner. The user can check user setting screen 320 after addition of object 11 without a special screen switching operation. As described with reference to step S314, an operation to cancel selection of object 11 and an operation to switch to normal setting screen 310 can be performed by a drag operation to move copy object 15 out of the screen. Therefore, in cancellation, switching from user setting screen 320 to normal setting screen 310 can be made without requiring a special operation by a user.

<L. Modification>

Though arrangement unit 43 arranges selected object 11 (copy object 15) at a position of a drag operation (a position of end of the drag operation (a drop position)), an operation for arrangement and a location of arrangement are not limited thereto. For example, when operation detector 40 detects a prescribed operation different in type from the drag operation such as an operation to press and hold or double-click preliminarily selected object 11, switching unit 41 switches normal setting screen 310 to user setting screen 320 in accordance with an output from operation detector 40. Arrangement unit 43 may arrange preliminarily selected object 11 at a prescribed position in switched user setting screen 320 (for example, at the bottom of user setting screen 320).

The user can also operate input apparatus 24 to select and delete object 11 in user setting screen 320. In this case, representation data generator 44 changes user screen representation data 51 so as to delete selected object 11 in accordance with a deletion operation detected by operation detector 40. Registration unit 45 deletes record 610 including a position of deleted object 11 in user setting screen 320 as position 611 from user setting screen data 61.

<M. Image Forming Apparatus>

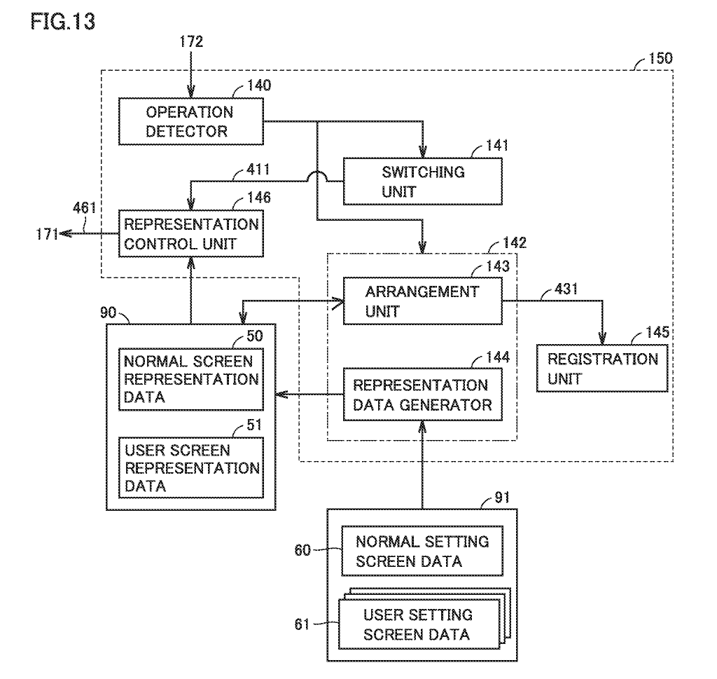

Image forming apparatus 100 according to one embodiment includes each unit shown in FIG. 4. FIG. 13 is a diagram showing one example of a functional configuration for editing the user setting screen of the image forming apparatus according to the embodiment. FIG. 13 shows each unit for edition of user setting screen 320 included in CPU 150 and peripherals thereof. CPU 150 in FIG. 13 represents one embodiment of the “information processing apparatus.”

Referring to FIG. 13, CPU 150 includes an operation detector 140, a switching unit 141, an edition unit 142 including an arrangement unit 143 and a representation data generator 144, a registration unit 145, and a representation control unit 146. The peripherals include a memory 90 for representation and a screen data memory 91 as one embodiment.

Screen data memory 91 corresponds to a non-volatile storage area of storage portion 160 or 153. Screen data memory 91 stores normal setting screen data 60 and user setting screen data 61 corresponding to at least one user similarly to screen data memory 48 in FIG. 4.

Memory 90 for representation represents one embodiment of an image memory. Memory 90 for representation stores normal screen representation data 50 and user screen representation data 51 similarly to memory 47 for representation in FIG. 4 for showing the normal setting screen on the screen (corresponding to the display screen) on display portion 171 of input and output portion 170.

Representation control unit 146 generates representation control data 461 from each of normal screen representation data 50 and user screen representation data 51 in memory 90 for representation and outputs generated representation control data 461 to display portion 171. The display on display portion 171 thus shows normal setting screen 310 or user setting screen 320.

Operation detector 140 functions similarly to operation detector 40 in FIG. 4. Specifically, operation detector 140 analyzes contents of an operation by a user accepted by input and output portion 170 or operation portion 172 and detects a type of the operation by the user based on a result of analysis.

Since switching unit 141, edition unit 142 including arrangement unit 143 and representation data generator 144, and registration unit 145 included in CPU 150 in FIG. 13 function similarly to switching unit 41, edition unit 42 including arrangement unit 43 and representation data generator 44, and registration unit 45 shown in FIG. 4, respectively, description will not be repeated.

Thus, in the embodiment, image forming apparatus 100 is configured to be able to edit a display screen in which input of setting of a setting item is accepted similarly to information processing terminal 200. Therefore, image forming apparatus 100 can accept an operation by a user from input and output portion 170, edit user setting screen 320 in accordance with contents of an operation by the user similarly to information processing terminal 200 described above, and show user setting screen 320 on display portion 171.

<N. Transmission of Screen Data>

In one embodiment, information processing terminal 200 transmits user setting screen data 61 to image forming apparatus 100. CPU 150 of image forming apparatus 100 receives user setting screen data 61 from information processing terminal 200 and has received user setting screen data 61 stored in screen data memory 91.

Thus, even though image forming apparatus 100 does not have a function to edit user setting screen 320, image forming apparatus 100 can show user setting screen 320 based on user setting screen data 61 received from information processing terminal 200 on display portion 171.

In one embodiment, image forming apparatus 100 transmits user setting screen data 61 to information processing terminal 200. In this case, even though information processing terminal 200 does not have a function to edit user setting screen 320, information processing terminal 200 can show user setting screen 320 based on user setting screen data 61 received from image forming apparatus 100 on display 23.

Screen data transmitted between image forming apparatus 100 and information processing terminal 200 is not limited to user setting screen data 61 and may include user screen representation data 51.

<O. Program>

A program for having information processing terminal 200 perform the processing described above is provided. Such a program can be provided, for example, as printer driver 400. Such a program can also be recorded on computer-readable storage medium 30 such as a flexible disk, a compact disk-read only memory (CD-ROM), ROM 21, RAM 22, and a memory card adapted to a computer of information processing terminal 200, and can be provided as a program product. Further, the program can also be recorded and provided in a recording medium such as a hard disk contained in the computer. Further, the program can also be provided by downloading through network 401. The program may be executed by at least one processor such as CPU 20 or combination of a processor and a circuit such as an ASIC or an FPGA.

The program may call a necessary module out of program modules provided as a part of an OS of the computer in a prescribed sequence and at prescribed timing and have the processor perform processing. In such a case, the program itself does not include the module above but executes the processing in cooperation with the OS. Such a program not including the module may also be encompassed in the program according to the embodiment.

The program according to the embodiment may be provided in a manner incorporated as a part of another program. In such a case as well, the program itself does not include the module included in another program, but the program has the processor perform the processing in cooperation with another program. Such a program incorporated in another program may also be encompassed in the program according to each embodiment.

Although embodiments of the present invention have been described and illustrated in detail, the disclosed embodiments are made for the purposes of illustration and example only and not limitation. The scope of the present invention should be interpreted by terms of the appended claims.

What is claimed is:

1. An information processing apparatus configured to edit a display screen in which input of setting of a setting item is accepted, the information processing apparatus comprising:
a hardware processor,
the display screen including a first screen including a first number of objects for accepting inputs of two or more setting items and a second screen including a second number of objects for accepting input of at least one setting item,
the hardware processor having the display screen switched from the first screen to the second screen when an operation by a user onto the display screen is a prescribed operation to select an object in the first screen while the first screen is shown as the display screen and having the selected object arranged in the switched second screen.

2. The information processing apparatus according to claim 1, wherein
the hardware processor detects the operation by the user onto the display screen, and
the prescribed operation includes a selection operation to move the object by changing a position of contact with the display screen while the object remains selected by an operation to touch the display screen.

3. The information processing apparatus according to claim 2, wherein
when the hardware processor detects that movement in the selection operation satisfies a prescribed condition, the hardware processor has the display screen switched from the first screen to the second screen.

4. The information processing apparatus according to claim 3, wherein
the prescribed condition includes a condition that a speed since start of movement has exceeded a prescribed speed.

5. The information processing apparatus according to claim 2, wherein
when an operation to cancel touching is performed during movement, the hardware processor has the object arranged at a position in the second screen corresponding to a position on the display screen where the operation to cancel touching has been detected.

6. The information processing apparatus according to claim 2, wherein
when an operation to cancel touching is performed during movement and when a position on the display screen where the operation to cancel touching has been detected corresponds to a position outside the second screen, the hardware processor cancels the selection operation.

7. The information processing apparatus according to claim 6, wherein
when the selection operation is canceled, the hardware processor further has the display screen switched from the second screen to the first screen.

8. The information processing apparatus according to claim 1, wherein
when the selected object is arranged in the second screen, the hardware processor further changes arrangement of other objects in the second screen.

9. The information processing apparatus according to claim 1, wherein
the hardware processor further has the selected object arranged at a prescribed position in the switched second screen.

10. The information processing apparatus according to claim 1, wherein
the prescribed operation includes an operation to select a plurality of objects.

11. The information processing apparatus according to claim 1, wherein
the hardware processor further controls the information processing apparatus to prohibit acceptance of the prescribed operation to select an object corresponding to the second number of objects in the second screen among the first number of objects in the first screen.

12. The information processing apparatus according to claim 1, wherein
the hardware processor further controls the display screen such that an object corresponding to the second number of objects in the second screen among the first number of objects in the first screen is shown in a prescribed manner.

13. The information processing apparatus according to claim 1, wherein
the setting item represents print setting contents.

14. An image forming apparatus comprising the information processing apparatus according to claim 1.

15. A computer-readable recording medium having a program stored thereon, the program having a computer perform a method of editing a display screen in which input of setting of a setting item is accepted,
the method including accepting an operation by a user onto the display screen,
the display screen including a first screen including a first number of objects for accepting inputs of two or more setting items and a second screen including a second number of objects for accepting input of at least one setting item,
the method further including
switching the display screen from the first screen to the second screen when the accepted operation by the user is a prescribed operation to select an object in the first screen while the first screen is shown as the display screen, and
arranging the selected object in the switched second screen.
